(19) United States
(12) Patent Application Publication
(10) Pub. No.: US 2015/0021189 A1
(43) Pub. Date: Jan. 22, 2015

(54) Multiplexed Detection Schemes for a Droplet Actuator

(71) Applicant: Advanced Liquid Logic, Inc., Research Triangle Park, NC (US)

(72) Inventors: Vijay Srinivasan, San Diego, CA (US); Vamsee K. Pamula, Durham, NC (US); Ramakrishna Sista, Morrisville, NC (US); Michael G. Pollack, San Diego, CA (US)

(73) Assignee: ADVANCED LIQUID LOGIC, INC., Research Triangle Park, NC (US)

(21) Appl. No.: 14/455,645

(22) Filed: Aug. 8, 2014

Related U.S. Application Data
(63) Continuation of application No. 12/681,848, filed on Apr. 14, 2010.
(60) Provisional application No. 60/980,487, filed on Oct. 17, 2007.

(51) Int. Cl. B01L 3/00

(52) U.S. Cl. CPC B01L 3/502792; B01L 3/502761; B01L 2400/0424; B01L 2400/0427; B01L 2300/0867; B01L 2200/0673; B01L 2300/088
USPC 204/643; 204/600

(57) ABSTRACT

A droplet actuator configured to improve the throughput of droplet operations in a detection spot of the droplet actuator and/or to reduce carryover problems is provided. The droplet actuator may include electrodes configured for effecting droplet operations transporting droplets on a surface; a sensor arranged in proximity to one or more of the electrodes establishing a detection window on the surface for detection of one or more properties of one or more droplets on the surface; wherein the electrodes may establish at least two pathways for transport of droplets into the detection window.

### RELATED PATENT APPLICATIONS

This application claims priority to U.S. patent application Ser. No. 60/980,487, entitled “Multiplexed detection schemes for a droplet actuator,” filed on Oct. 17, 2007, the entire disclosure of which is incorporated herein by reference.

### GOVERNMENT INTEREST

This invention was made with government support under DK066956-02 and GM072155-02 awarded by the National Institutes of Health of the United States. The United States Government has certain rights in the invention.

### BACKGROUND OF THE INVENTION

Carryover of substances, such as compounds or beads, as well as carryover of signals, could be increased on a droplet microactuator when a single detection spot is used multiple times. Carryover can result in deposition of materials on a surface which interferes with droplet operations of subsequent droplets. Deposition of materials on a surface can also result in background signal, which interferes with detection of signal from subsequent droplets. Further, where the droplet actuator is made using fluorescent or phosphorescent substrate, such as the FR-4 material used in a PCB, the fluorescence or phosphorescence in the region of a detector can be enhanced by photons emitted from droplets, thereby interfering with detection of subsequent droplets. The inventors refer to this and other means of optical interference as “optical carryover.” Based on these observations, the inventors have identified a need for alternative approaches to presenting droplets to sensors for detection that reduce problems caused by carryover and increase the bandwidth for the number of droplets that are multiplexed at a detection area.

### SUMMARY OF THE INVENTION

The invention provides a droplet actuator. In one embodiment, the droplet actuator includes electrodes configured for effecting droplet operations transporting droplets on a surface and a sensor arranged in proximity to one or more of the electrodes establishing a detection window on the surface for detection of one or more properties of one or more droplets on the surface. The electrodes may establish at two or more pathways for transport of droplets into the detection window. A droplet may be provided on one or more of the electrodes on the pathways. A droplet may be provided on the one or more paths of electrodes in the detection window. Using droplet operations, a droplet may be transported along a path of electrodes into the detection window.

In some cases, the droplet is partially or completely surrounded by a filler fluid. The filler fluid may include an oil, such as a silicone oil. In certain embodiments, the detection spot is aligned with a hydrophilic patch on the surface. In certain embodiments, the droplet actuator includes a substrate and at least a partial perimeter enclosing the surface and configured to provide a gap in which the droplet operations may be conducted. This is an example of a configuration which permits the droplet to be enclosed between the surface and a separate substrate.

In some embodiments, the droplet includes beads. The droplet may include biological cells or organisms. The droplet may include beads with biological cells adhered thereto.

In some embodiments, the electrode paths are arranged generally radially with respect to a point located within the detection window. In some embodiments, the electrode paths are arranged generally radially with respect to a center of the detection window. Further, in certain embodiments, the electrode paths are arranged generally radially relative to a central electrode positioned in the detection window. Moreover, the electrode paths may be arranged generally radially relative to an electrode loop positioned generally concentrically at least partially within the detection window. Moreover, the electrode paths may be arranged generally radially relative to an electrode loop positioned generally concentrically within the detection window.

In certain embodiments, the electrode paths are arranged generally radially relative to a point in the detection window; and are connected to each other by one or more additional electrode paths. In certain embodiments, the electrode paths are arranged generally radially relative to a center of the detection window; and are connected to each other by one or more additional electrode paths. For example, the one or more additional electrode paths may include a loop positioned generally concentrically outside the detection window.

In certain embodiments, the droplet operations include electrode-mediated droplet operations. For example, the droplet operations may include electrowetting-mediated droplet operations, dielectrophoresis-mediated droplet operations, electrostatic-mediated operations or combinations of electrowetting-mediated droplet operations, dielectrophoresis-mediated droplet operations, and electrostatic-mediated operations. Other examples of techniques for effecting droplet operations include opto-electrowetting, optical tweezers, surface acoustic waves, thermocapillary-driven droplet motion, chemical surface energy gradients, and pressure or vacuum induced droplet motion.

In some embodiments, the electrode paths establish a single path to each detection spot in each detection window. In other embodiments, the electrode paths establish two or more paths to a single detection spot in a detection window. In still other embodiments, the electrode paths establish at least three pathways for transport of droplets into the detection window. In still other embodiments, the electrode paths establish at least four pathways for transport of droplets into the detection window. In still other embodiments, the electrode paths establish at least five pathways for transport of droplets into the detection window. In still other embodiments, the electrode paths establish at least six pathways for transport of droplets into the detection window. In still other embodiments, the electrode paths establish at least nine pathways for transport of droplets into the detection window. In still other embodiments, the electrode paths establish at least twelve pathways for transport of droplets into the detection window.

In some embodiments, the electrodes include electrodes established in a regular rectangular array, and electrodes converging from the rectangular array into a detection window. For example, the electrodes may be arranged in a polygonal pattern including polygonal electrodes, wherein each electrode has five or more sides.

In certain embodiments the electrode paths join the detection window with two or more droplet actuator unit cells. For example, the unit cells may include at least one nucleic acid amplification unit cell including a droplet actuator configuration suitable for amplifying a nucleic acid. As another example, the unit cells may include at least one affinity assay unit cell, including a droplet actuator configuration suitable for conducting an affinity based assay. As yet another example, the unit cells may include at least one enzymatic assay unit cell, including a droplet actuator configuration suitable for conducting an enzymatic assay.

The invention also provides a method of detecting a property of a target droplet. For example, such a method may include using droplet operations to modulate signals from a droplet set including the target droplet. The modulated signals of the droplet set may be detected. The signals may be demodulated to identify the signal produced by one or more individual droplets from the set.

The droplet set is provided on a droplet actuator of the invention. In some cases, the droplets may include beads, and the property may be indicative of a property of the beads. In some cases, one or more of the droplets may include an analyte, and the property may be indicative of a quality and/or quantity of the analyte, such as presence/absence The droplet may include biological cells, and the property may be indicative of a property of the biological cells.

The modulation of the droplet may be effected using a variety of techniques, such as moving droplets into and out of a detection window; moving droplets into and out of a detection window, where each droplet is moved into and out of the detection window at a different frequency; moving droplets into and out of a detection window along electrode paths; moving droplets into and out of a detection window along electrode paths that are arranged in a generally radial manner; moving droplets into and out of a detection window by electrode-mediated droplet operations; moving droplets into and out of a detection window by electrowetting-mediated droplet operations; moving droplets into and out of a detection window by dielectrophoresis-mediated droplet operations; moving droplets from one location to another in a detection window; moving different droplets different distances in a detection window; moving droplets into and out of a detection window where different droplets traverse different distances within the detection window; moving droplets into and out of a detection window where different droplets travel different directions within the detection window; moving droplets into and out of one or more openings in a surface of a droplet actuator; and any combinations of the foregoing techniques.

The invention also includes a system including a droplet actuator and a processor electronically coupled to the processor. The system may include software for conducting any of the methods of the invention. Various aspects of the software may, for example, be stored in memory, loaded in the processor, and/or stored on long-term storage.

### BRIEF DESCRIPTION OF THE DRAWINGS

FIG. 1 illustrates an electrode layout in which electrode paths converge on different detection spots within a detection window;

FIG. 2 illustrates an electrode layout in which electrode paths converge on a central electrode, which may also serve as a detection spot;

FIG. 3 illustrates an electrode layout in which electrode paths converge on a looped electrode path that is located within the detection window;

FIG. 4 illustrates an electrode layout in which the converging electrode paths are connected by a looped electrode path which lies outside the detection window;

FIG. 5 illustrates an electrode layout in which electrode paths converge on a central electrode, with a branching electrode network surrounding electrode paths which converge within a detection window;

FIGS. 6A and 6B show an electrode layout in which converging electrode paths are generally based on a grid of square electrodes;

FIGS. 7A and 7B show an electrode layout in which converging electrode paths are generally based on a hex-grid of hexagonal electrodes;

FIG. 8 illustrates an electrode layout including a network and a set of converging paths terminating in a detection window;

FIG. 9 illustrates an electrode layout including a network and a set of converging paths terminating in a detection window, and also includes a series of unit layouts, which may be same or different, connected by electrode paths to a detection window;

FIGS. 10A and 10B show a droplet actuator comprising a first substrate associated with a path or array of electrodes for conducting droplet operations, and a second substrate having substantially opaque regions and substantially transparent regions;

FIGS. 11A, 11B, 11C, and 11D show a droplet actuator comprising a first substrate associated with a path or array of electrodes for conducting droplet operations, and a second substrate having substantially opaque regions and openings into which a droplet may flow by capillary force; and

FIG. 12 illustrates an electrode layout in which electrode paths converge on different detection spots within a detection window.

### DEFINITIONS

As used herein, the following terms have the meanings indicated.

“Activate” with reference to one or more electrodes means effecting a change in the electrical state of the one or more electrodes which results in a droplet operation.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical and other three dimensional shapes. The bead may, for example, be capable of being transported in a droplet on a droplet actuator or otherwise configured with respect to a droplet actuator in a manner which permits a droplet on the droplet actuator to be brought into contact with the bead, on the droplet actuator and/or off the droplet actuator. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead or one component only of a bead. The remainder of the bead may include, among other things, polymeric material, coatings, and moieties which permit attachment of an assay reagent. Examples of suitable magnetically responsive beads are described in U.S. Patent Publication No. 2005-0260686, entitled, “Multiplex flow assays preferably with magnetic particles as solid phase,” published on Nov. 24, 2005, the entire disclosure of which is incorporated herein by reference for its teaching concerning magnetically responsive materials and beads. The fluids may include one or more magnetically responsive and/or non-magnetically responsive beads. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference.

“Droplet” means a volume of liquid on a droplet actuator that is at least partially bounded by filler fluid. For example, a droplet may be completely surrounded by filler fluid or may be bounded by filler fluid and one or more surfaces of the droplet actuator. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. A droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. A droplet may include a reagent, such as water, deionized water, saline solutions, acidic solutions, basic solutions, detergent solutions and/or buffers. A droplet may include a reagent, such as a reagent for a biochemical protocol, such as a nucleic acid amplification protocol, an affinity-based assay protocol, an enzymatic assay protocol, a sequencing protocol, and/or a protocol for analyses of biological fluids.

“Droplet Actuator” means a device for manipulating droplets. For examples of droplets, see U.S. Pat. No. 6,911,132, entitled “Apparatus for Manipulating Droplets by Electrowetting-Based Techniques,” issued on Jun. 28, 2005 to Pamula et al.; U.S. patent application Ser. No. 11/343,284, entitled “Apparatuses and Methods for Manipulating Droplets on a Printed Circuit Board,” filed on filed on Jan. 30, 2006; U.S. Pat. Nos. 6,773,566, entitled “Electrostatic Actuators for Microfluidics and Methods for Using Same,” issued on Aug. 10, 2004 and 6,565,727, entitled “Actuators for Microfluidics Without Moving Parts,” issued on Jan. 24, 2000, both to Shenderov et al.; Pollack et al., International Patent Application No. PCT/US2006/047486, entitled “Droplet-Based Biochemistry,” filed on Dec. 11, 2006, the disclosures of which are incorporated herein by reference. Methods of the invention may be executed using droplet actuator systems, e.g., as described in International Patent Application No. PCT/US2007/009379, entitled “Droplet manipulation systems,” filed on May 9, 2007. In various embodiments, the manipulation of droplets by a droplet actuator may be electrode mediated, e.g., electrowetting mediated or dielectrophoresis mediated.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; condensing a droplet from a vapor; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to size of the resulting droplets (i.e., the size of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. In various embodiments, the droplet operations may be electrode mediated, e.g., electrowetting mediated or dielectrophoresis mediated.

“Filler fluid” means a fluid associated with a droplet operations substrate of a droplet actuator, which fluid is sufficiently immiscible with a droplet phase to render the droplet phase subject to electrode-mediated droplet operations. The filler fluid may, for example, be a low-viscosity oil, such as silicone oil. Other examples of filler fluids are provided in International Patent Application No. PCT/US2006/047486, entitled, “Droplet-Based Biochemistry,” filed on Dec. 11, 2006; and in International Patent Application No. PCT/US2008/072604, entitled “Use of additives for enhancing droplet actuation,” filed on Aug. 8, 2008.

“Immobilize” with respect to magnetically responsive beads, means that the beads are substantially restrained in position in a droplet or in filler fluid on a droplet actuator. For example, in one embodiment, immobilized beads are sufficiently restrained in position to permit execution of a splitting operation on a droplet, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

“Washing” with respect to washing a magnetically responsive bead means reducing the amount and/or concentration of one or more substances in contact with the magnetically responsive bead or exposed to the magnetically responsive bead from a droplet in contact with the magnetically responsive bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Other embodiments are described elsewhere herein, and still others will be immediately apparent in view of the present disclosure.

The terms “top” and “bottom” are used throughout the description with reference to the top and bottom substrates of the droplet actuator for convenience only, since the droplet actuator is functional regardless of its position in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### DESCRIPTION OF THE INVENTION

The invention provides droplet actuators configured to improve the throughput of droplet operations in a detection spot of the droplet actuator and/or to reduce carryover problems, such as carry over problems related to biochemical, chemical, particulate, bead, and/or optical carryover at a detection spot. A detection spot is a location on a droplet microactuator where a droplet is positioned during detection of a property of a droplet. A detection spot may be associated with one or more electrodes configured for conducting droplet operations; however, droplets may be placed on detection spots using a variety of other mechanisms as well, such as hydrophilic or hydrophobic surfaces and/or droplet movement controlled by movement of filler fluid in the droplet actuator. The detection spot is typically in proximity to a sensor apparatus, such as a photomultiplier tube (PMT) or a photon counting PMT or a photodiode or an electrochemical sensor. The invention provides several alternative approaches to solving the throughput issues associated with the detection spot. In one approach, illustrated by certain examples described in Section 7.1, the droplet actuator includes multiple detection spots within the diameter of exposure to the sensor, which we refer to as the “detection window” of the sensor. In this manner, multiple droplets can undergo detection without requiring all droplets to pass over or reside on the same detection spot. In another approach, illustrated by certain examples described in Section 7.2, the conformations or positions of multiple droplets are modulated in the presence of the detector to create a signal, which can be demodulated to quantify the signal of each independent droplet.

### 7.1 Multiple Detection Spot Arrangements

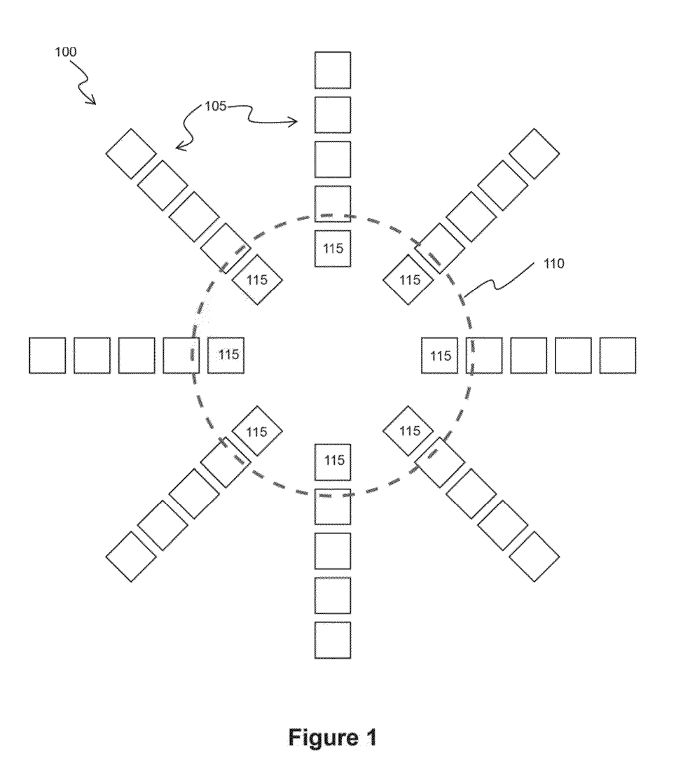

FIGS. 1-8 describe a variety of configurations in which multiple paths are used to deliver multiple droplets to multiple detection spots. In various embodiments, this approach provides at least one detection window including at least two detection spots to which droplets may be delivered via different paths (though it will be appreciated that the different paths may together form a single large path).

FIG. 1 illustrates an electrode layout in which electrode paths converge on different detection spots within a detection window. The figure illustrates an electrode layout 100, which may be a portion of a larger electrode layout not shown. Electrode layout 100 includes multiple electrode paths 105, which converge radially within a detection window, 110. Terminal electrodes 115 of electrode paths 105 serve as detection spots within detection window 110. Other droplet operations, such as droplet merging and/or splitting, may also be conducted on any of converging electrode paths 105 or at the terminal electrodes 115. Since multiple electrodes can serve to hold droplets for detection, carryover, if any, between droplets at the terminal electrodes is distributed over several electrodes.

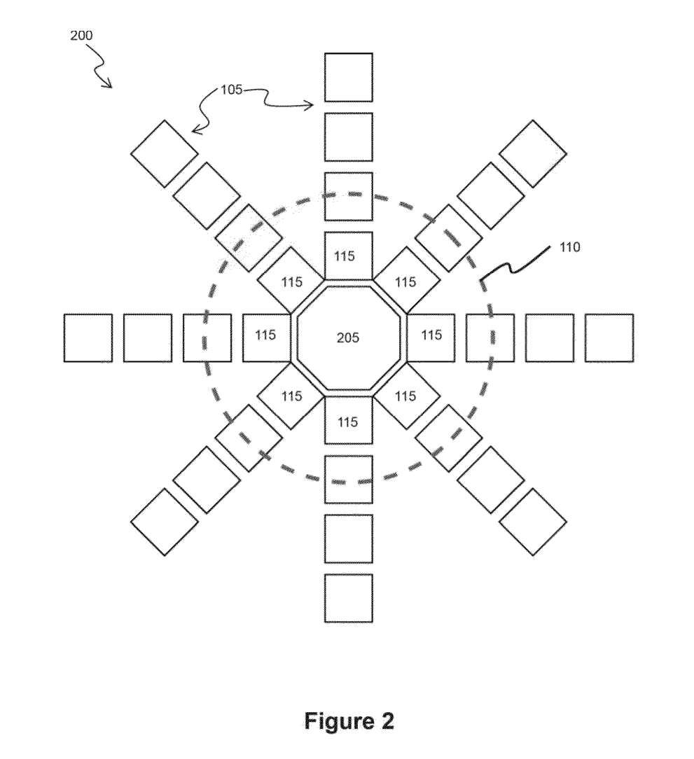

FIG. 2 illustrates another electrode layout 200, which is similar to the layout in FIG. 1, except that electrode paths 105 converge on a central electrode 205, which may also serve as a detection spot. Other droplet operations, such as droplet merging and/or splitting, may also be conducted on any of converging electrode paths 105 or the terminal electrodes 115 or the central electrode 205. The central electrode 205, can take a number of shapes including polygons and circular shapes. This approach enables quickly moving multiple droplets onto and off of a central detection spot, where a droplet can be transported onto central electrode 205 and transported away from central electrode 205 along the same electrode path, i.e., the droplet retraces its path of entry. Alternatively, a droplet may move forward across central electrode 205 and exit along a path which is different from the entry path. This configuration is particularly useful in settings in which the detector is too small to take measurements from multiple detection spots and where throughput at the detection spot needs to be higher.

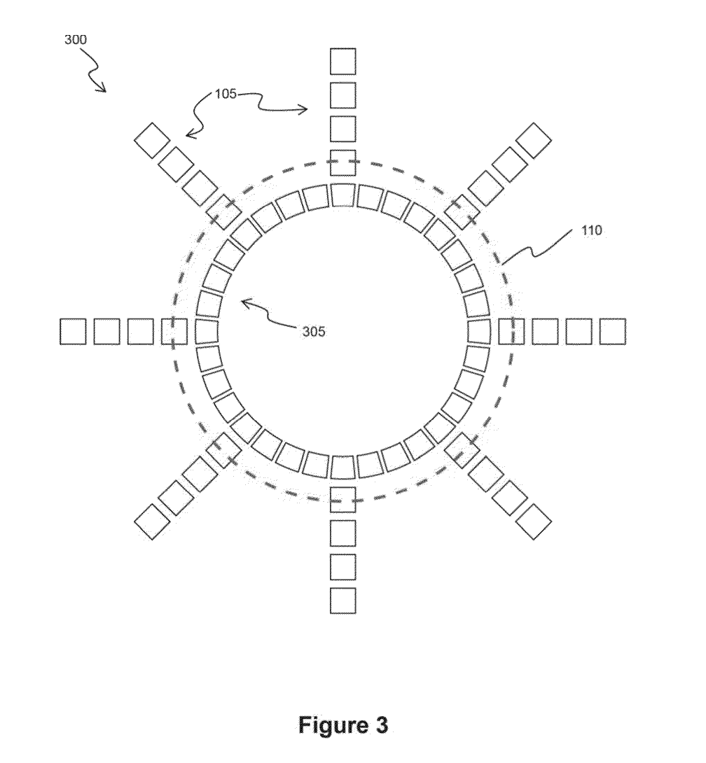

FIG. 3 illustrates another electrode layout 300, which is also similar to the layout in FIG. 1, except that the electrode paths converge on a looped electrode path 305 that is located within the detection window 110. Further, electrodes 105 may converge into the loop electrodes in other non-radial patterns, and the loop electrodes may be arranged in other non-circular shapes. Further, in various embodiments, the loop may be closed or open in one or more regions. Any of the electrodes on looped electrode path 305 may serve as a detection spot for any droplet entering looped electrode path 305 from any of converging electrode paths 105. Other droplet operations, such as droplet merging and/or splitting, may be conducted on looped electrode path 305 or on any of the converging electrode paths 105. Among other things, this embodiment enables substantially parallel or sequential feeding of multiple droplets onto looped electrode path 305, which can serve as a detection loop.

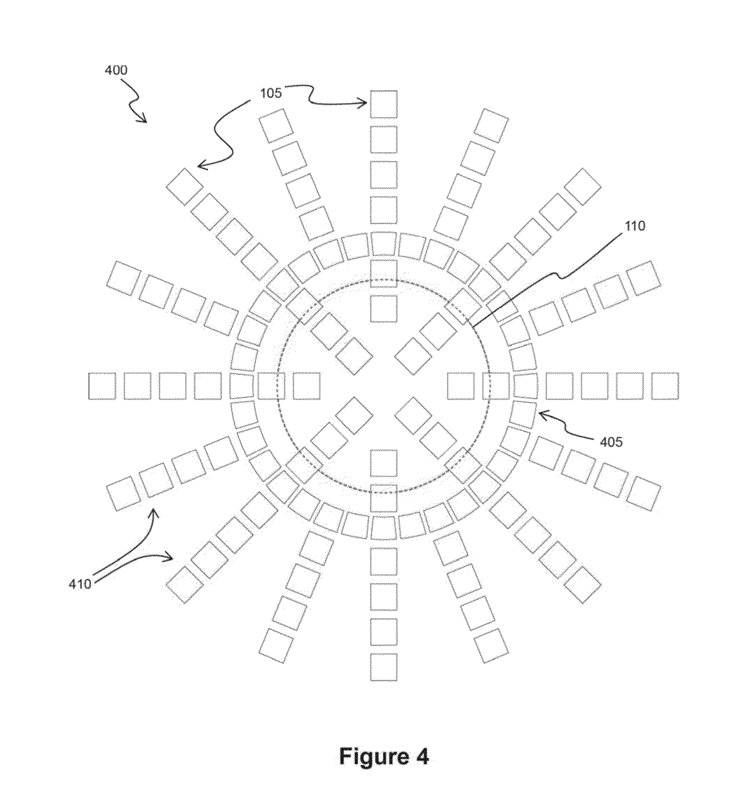

FIG. 4 illustrates another electrode layout 400, which is also similar to the layout in FIG. 1, except that the converging electrode paths 105 are connected by looped electrode path 405, which lies outside the detection window. Any droplet entering any of the converging electrode paths 105 can be diverted along looped electrode path 405 to any other of the converging electrode paths 105. Further, droplets entering different converging electrode paths 105 can be merged on looped electrode path 405 or on any of the converging electrode paths 105. Electrode layout 400 may also include branches off looped electrode path 405, such as radial branches 410. Once merged, such merged droplets may be conducted to any of converging electrode paths 105 for presentation to the detection window 110 at any of the detection spots 105. Other droplet operations, such as droplet merging and/or splitting, may be conducted on looped electrode path 405 or on any of converging electrode paths 105. In this example, since the looped electrode path has more number of electrodes than the number of electrodes within the detection window, more number of droplets can be held or incubated, if needed, on the looped electrode path. Therefore this looped electrode path can be used as a buffer to hold several droplets which can wait their turn to be presented to the detection window.

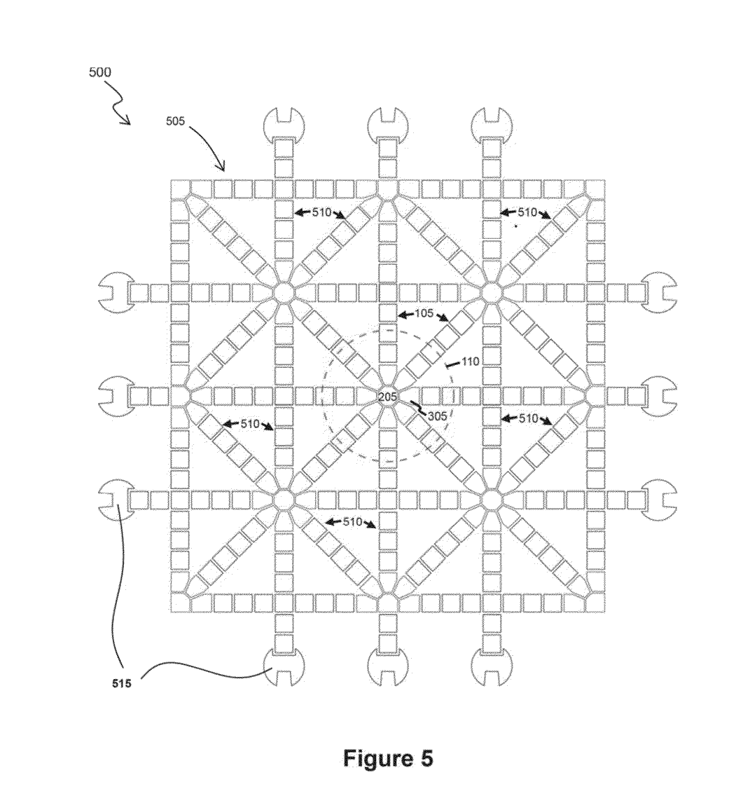

FIG. 5 illustrates an electrode layout 500, which is similar to the electrode layout 200 in FIG. 2. Layout 500 shows a branching electrode network 510 surrounding converging electrode paths 105, which converge within detection window 110. Converging electrode paths 105 include electrodes located within detection window 110, any of which may be used as a detection spot. A central electrode 205 is shown, but this electrode may or may not be present. A looped electrode path 305 is also shown, which may or may not be present.

Electrode network 505 includes electrode paths surrounding converging electrode paths 105 and arranged to supply droplets to converging electrode paths 105. Droplets entering different converging electrode paths 105 can, for example, be subjected to droplet operations on network 505 and/or on any of converging electrode paths 105. Once merged, such merged droplets may be conducted to any of converging electrode paths 105 for presentation to detection window 110 at any of the electrodes within detection window 110.

In the specific embodiment shown, electrode network 510 includes multiple converging droplet operation paths outside detection window 110. The layout of electrode network 510 provides flexibility in droplet operations prior to or following presentation of droplets to detection window 110. Since the layout of the detection window, 110, is replicated 5 times in FIG. 5, the detection can be performed on any one of the windows. If a detection window is used several times and for reasons of carry over, if detection needs to be performed elsewhere it can be performed on the other detection windows by simply moving the droplet actuator or the detector so that the detector aligns with another detection window. In other embodiments, multiple detection windows may be aligned with multiple detectors.

Further, electrode layout 500 includes reservoir electrodes 515 that can be used to dispense droplets, such as sample and/or reagent droplets onto network 505 and/or to receive droplets from network 505.

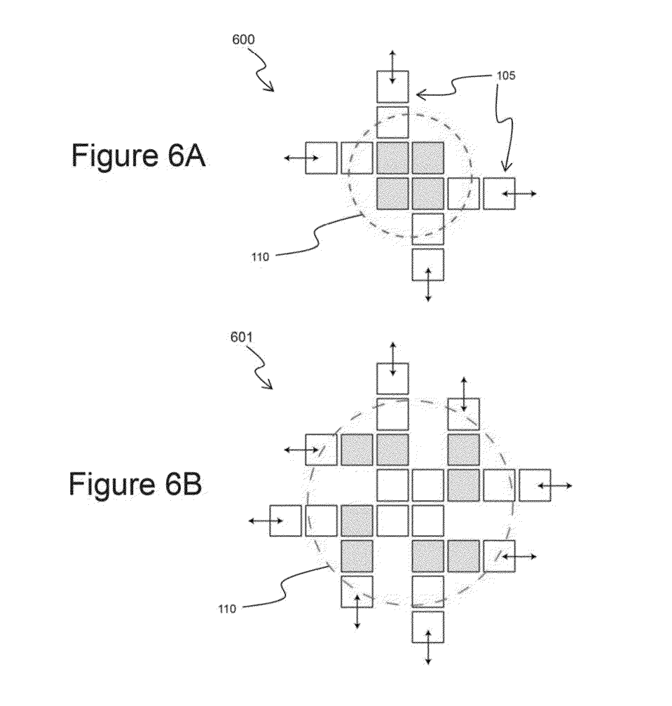

FIG. 6 shows an electrode layout in which converging electrode paths are generally based on a grid of square electrodes. Electrode layouts 600 and 601, which may form regions of larger electrode layouts (not shown), include electrode paths 105 oriented generally on a plane in x,y directions, where x and y are generally at right angles to one another. Electrode paths 105 terminate within detection window 110. FIG. 6A illustrates an embodiment in which four electrode paths 105 converge at right angles within detection window 110 on a grid of four detection spot electrodes. Several unit-sized droplets can be combined within the detector window to form a larger droplet. FIG. 6B illustrates an embodiment in which electrode paths 105 converge within detection window 110 on an arrangement of eight detection spot electrodes. It should be noted that these figures only serve as examples and in practice any two dimensional array of electrodes (of any shape, whether resulting in close packed structures or not) can be configured to enable detection of multiple droplets. For example, in FIG. 6, instead of sparsely packed electrodes, the structure could be completely packed with electrodes.

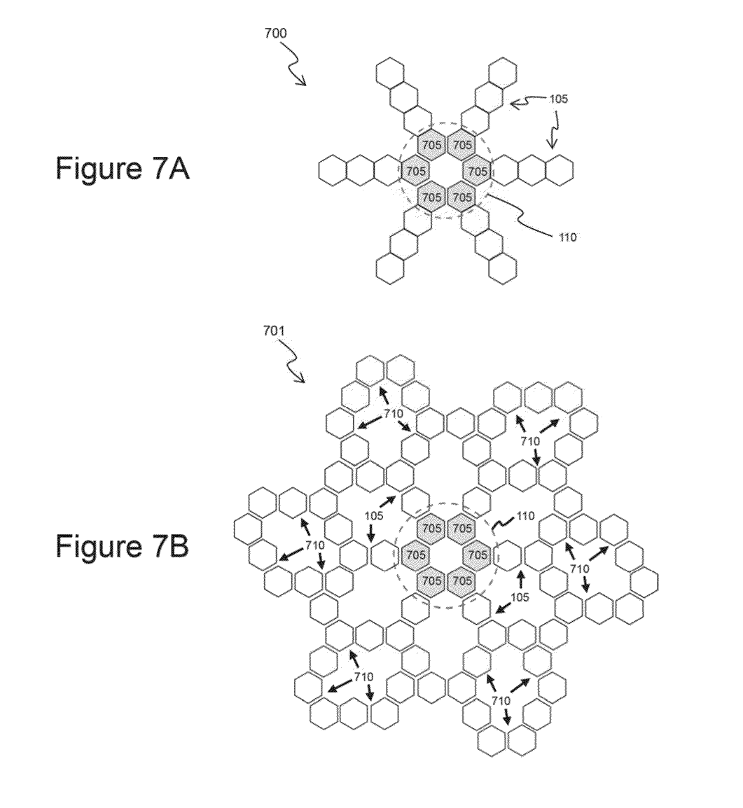

FIG. 7 shows an electrode layout 700,701 in which converging electrode paths are generally based on a hex-grid of hexagonal electrodes. Electrode layouts 700 and 701, which may form regions of larger electrode layouts (not shown), include electrode paths 105 oriented generally on a plane in x,y,z directions, where x, y and z are generally at 60 degree angles to one another. Electrode paths 105 are oriented in a generally radial fashion relative to one another and terminate within detection window 110. Similar to a rectangular or square pattern, a hexagonal pattern fits a close-packed structure, therefore the electrodes may be fully packed. In such a layout, the electrode paths 105 need not necessarily be arranged in a radial pattern. Further, the detection window 110, as well as the detection windows in all embodiments described herein, may be provided in other shapes, such as oval, square, slit, rectangular, polygonal, etc., and in various embodiments may also include optical elements, such as lenses, filters and diffraction gradients. FIG. 7A illustrates an embodiment in which electrode paths 105 converge within detection window 110 on a hexagonal arrangement of six hexagonal detection spot electrodes 705. FIG. 7B illustrates an electrode layout in which electrode paths 105 are arranged within an electrode network 710, which is based on hexagonal electrodes. It will be appreciated that any electrode shapes can be used to create arrays similar to those shown in FIGS. 6 and 7, e.g., polygons, circles, ovals, etc. Polygons that can be closely packed such as triangle, square, rectangle, hexagon etc are preferred but not required.

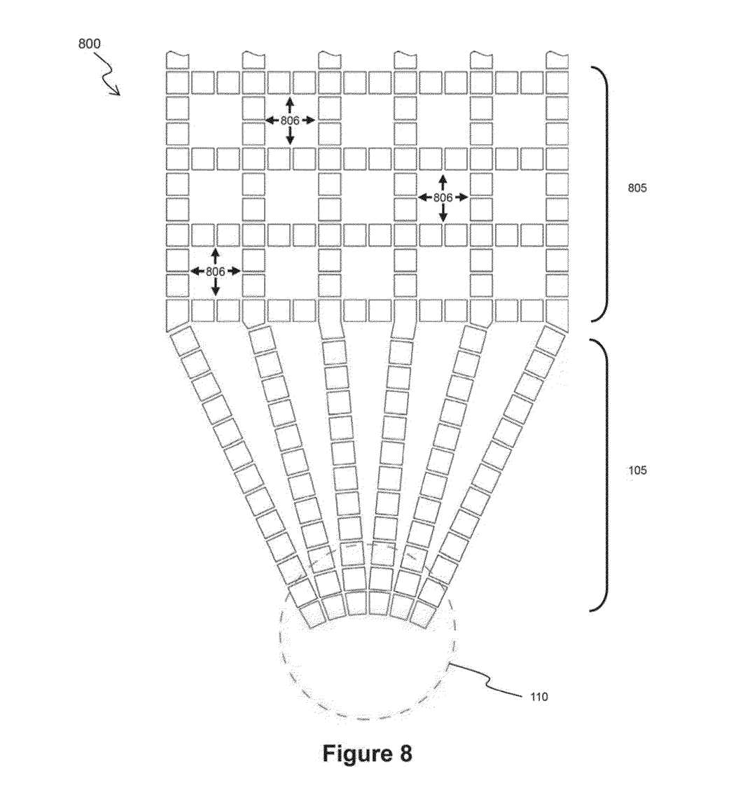

FIG. 8 illustrates an electrode layout 800 including a network 805, which may form a region of a larger electrode layout (not shown), and a set of converging paths 105 terminating in detection window 110. Network 805 includes paths 806 of electrodes oriented generally on a plane in x,y directions, where x and y are generally at right angles to one another. Converging paths 105 are oriented in a generally radial fashion, radiating outwardly from detection window 110 and arranged to permit droplets to be transported from network 805 into detection window 110.

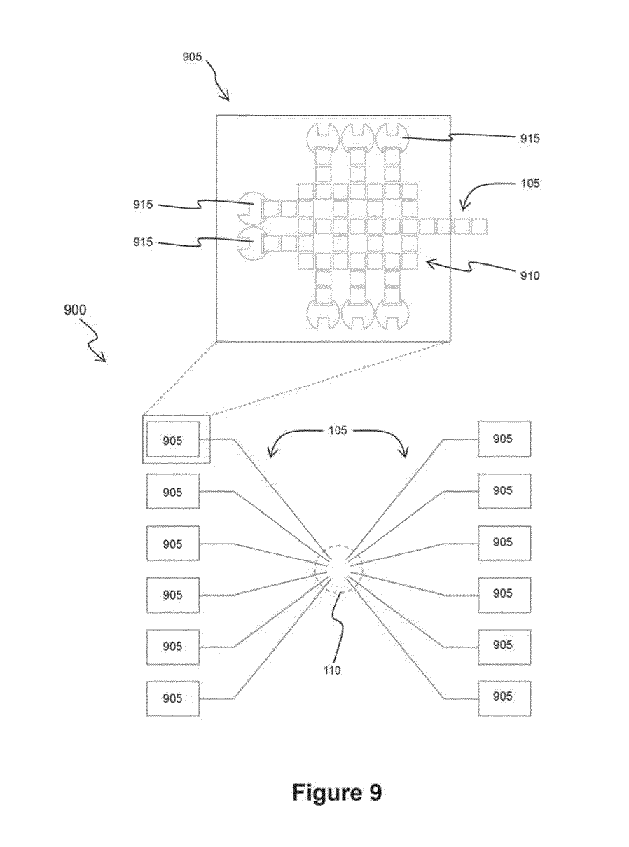

FIG. 9 illustrates an electrode layout similar to the layout shown in FIG. 8, except that this layout includes a series of unit layouts 905, which may be same or different, connected by electrode paths 105 to a detection window 110. Electrode paths 105 may be radially oriented relative to detection window 110, or oriented as a grid or any other arrangement that permits droplets to be transported from unit cells 905 onto detection spots within detection window 110. The unit layout 905 illustrated, includes an electrode network 910 associated with reservoir electrodes 915 for dispensing droplets onto the network. Any of a variety of electrode arrays may be included as unit layouts 905; the specific embodiment shown in FIG. 9 is only one example. For example, one layout conforms to the SBS multiwell plate footprint with one or several detection windows on the droplet actuator between several unit layouts 905 in the same pitch as the SBS multiwell plate. Each such unit layout could be configured to perform different series of droplet operations. This droplet actuator can be loaded into a multiwell plate reader, which has a moving detector head which moves to each of the detection windows to collect signals or it can be provided with a fixed detector head which will be coupled to a single detection window on the droplet actuator to which all the droplets will be moved for detection.

### 7.2 Modulation of Signals

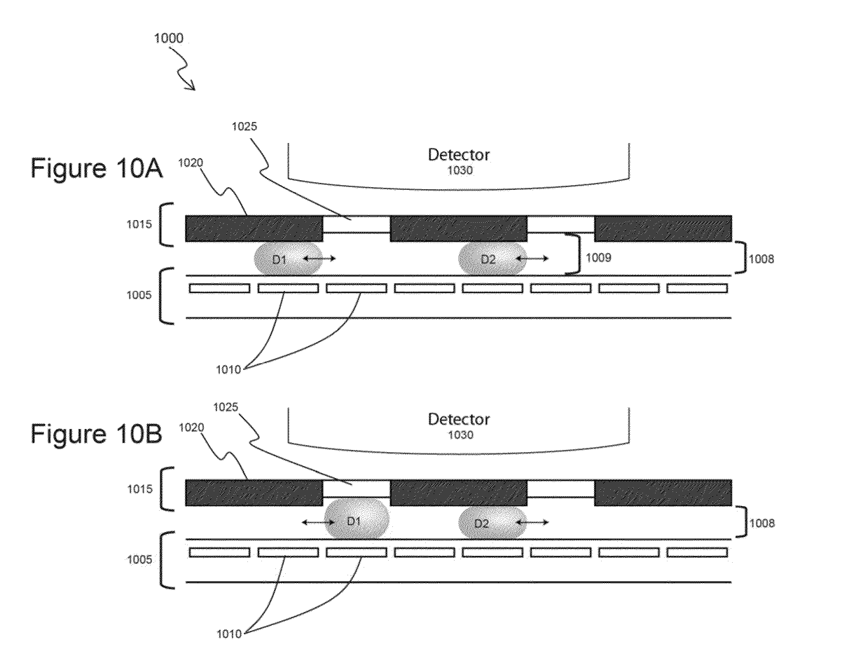

FIG. 10 shows droplet actuator 1000 comprising first substrate 1005 associated with a path or array of electrodes 1010 for conducting droplet operations. Droplet actuator 1000 also includes a second substrate 1015 having substantially opaque regions 1020 and substantially transparent regions 1025. First substrate 1005 and second substrate 1015 are separated to form gap 1008. Droplets D1, D2 are positioned in gap 1008. A detector, such as a PMT for example, is positioned in sufficient proximity to transparent regions 1025 to detect a signal from a droplet D1, D2. The arrangement can be as shown in FIG. 10, where the substantially transparent regions 1025 establish a wider gap 1009 to bring the droplet in closer proximity to the detector; alternatively, substantially transparent regions 1025 may have a gap which is greater or less than the gap 1008 in the opaque region. The transparent region need only be sufficiently transparent to permit the desired signal to reach the detector.

In the approach shown, droplets D1, D2 may be moved from under opaque region 1020 to under transparent region 1025 and back, as shown for D1 in FIG. 10B. Each droplet may be modulated into and out of the detection window at frequencies that are out of phase with each other.

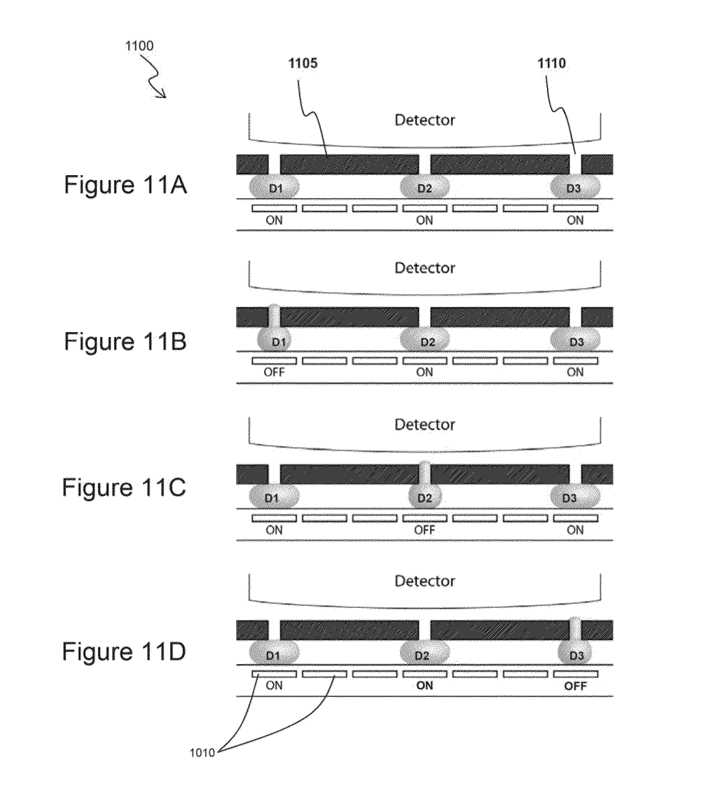

FIG. 11 shows droplet actuator 1100 which is similar to the droplet actuator shown in FIG. 10, except that the second substrate of droplet actuator 1100 includes opaque areas 1105 and openings 1110 into which a droplet D1, D2, D3 may flow by capillary force. When an electrode 1010 adjacent to an opening 1110 is activated (ON), droplet D1, D2, D3, etc. associated with electrode 1010 conforms to the shape of the electrode 1010. When an electrode 1010 adjacent to an opening 1110 is not activated (OFF), droplet D1, D2, D3, etc. associated with electrode 1010 is freed to enter opening 1110.

In the approach shown, electrodes 1010 associated with droplets D1, D2, D3 may be activated/deactivated at different times and/or at different frequencies. For example, each droplet D1, D2, D3 may be modulated into and out of associated opening 1110 at a different frequency, e.g., D1 at 2 Hz, D2 at 3 Hz, D3 at 4 Hz, etc. A set of linear equations can be used to demodulate and solve for the signal output for each droplet.

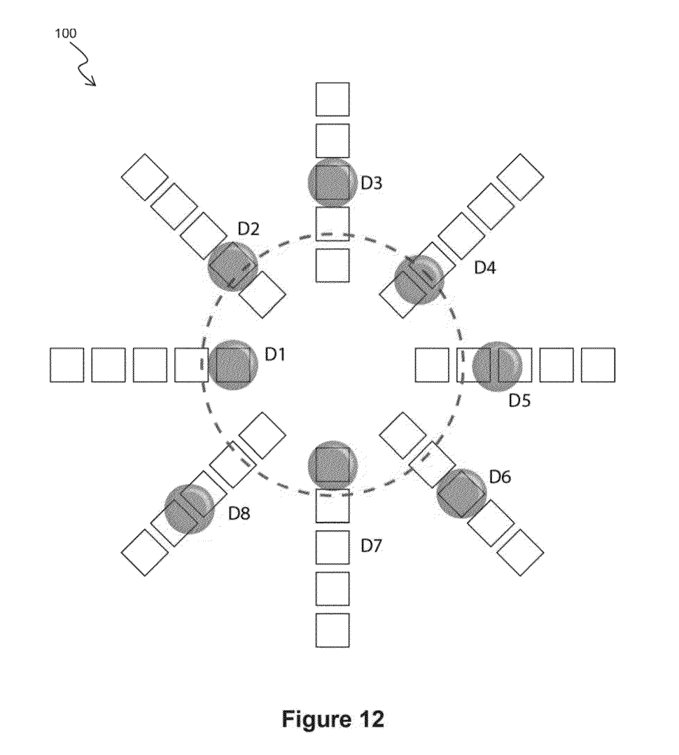

FIG. 12 shows the electrode layout 100 of FIG. 1 with droplets D1-D8 being modulated into and out of the detection window 110, with each droplet being moved in and out of detection window 110 at a different frequency. In some cases, each droplet may be subject to a different detection protocol and may need to arrive at the detector at different times. In such cases, pipelining all the droplets serially may not be optimally maintaining the throughput at the detection spot, therefore each droplet can be measured as it comes to the detection area along with and in the presence of other droplets. In another scenario, all the droplets may have arrived at the detection spot but the signal from each droplet may need to be collected for different amounts of time. For example, a droplet may need to be detected over 20 sec, another over 15 sec, and yet another over 5 sec. In this case, the droplet requiring longest exposure (20 sec) can be moved into and out of the detection window at a fixed frequency first, and the signal measured as time progresses for any kinetic measurements, and then the next droplet (15 sec) can be added either at the same frequency or a different frequency and the signal measured with both the droplets moving into and out of the detection window, and then the next droplet (5 sec) can be added either at the same frequency or a different frequency and the signal measured with all 3 the droplets moving into and out of the detection window. These approaches can be generalized as, Measured Signal=k₁D₁(t)+k₂D₂(t)+k₃D₃(t)+ . . . k₈D₈(t) . . . +kₙDₙ(t), where Dₙ is the signal output of each droplet, and where kₙ=1 if the droplet is in the detection window and 0 if the droplet is outside the detection window. A set of linear equations can be derived to resolve the signal measured from each droplet. In a related embodiment, signal may also be collected as a droplet is approaching the detection window, using a fractional multiplier depending on the distance of the droplet from the detector. In this embodiment, by the time the droplet fully enters the detection window, sufficient data has already been collected to quantify signal output.

In all the examples listed above, several droplet operations could be performed on the electrodes within the detector window. For example, for droplets containing enzymes/substrates, substrates/enzymes could be added at the detection spot so that any transient data could be collected right from the time of mixing the two droplets such as is done in a sample injector. This would be a very useful feature to study transitory signals such as produced in bio/chemiluminescence. Droplets can be split off at the detector window. Serial dilutions of a sample could be performed in this window to study dilutions. Magnets can be placed in proximity to the detection window so that magnetic beads can be held and washed at the detection window to enable real-time measurements on species adsorbed to the beads or desorbed from the beads. Beads could be immobilized in several different ways including magnets, physical barriers etc. Measurements could also be performed on cells and surface immobilized species within the detector window.

### 7.3 Detection Methods

The electrode layouts presented here can be used in a variety of detection schemes. In one scheme, droplets are sequentially presented to the detection window, one at a time. In some embodiments, each detection spot is presented with only one droplet for detection. In other embodiments, each detection spot is presented with multiple droplets, but the total number of droplets being presented for detection is divided substantially equally among multiple detection spots. In another scheme where high throughput is desired, multiple droplets are presented at approximately the same time (rather than serially), and the cumulative measurement is taken and compared against an expected result. If the actual result does not match the expected result, then the one or more problem droplets can be identified. This approach is useful, for example, in process monitoring settings. Other methods are as described above.

### CONCLUDING REMARKS

The foregoing detailed description of embodiments refers to the accompanying drawings, which illustrate specific embodiments of the invention. Other embodiments having different structures and operations do not depart from the scope of the present invention. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation, as the present invention is defined by the claims as set forth hereinafter.

We claim:

1. A droplet actuator comprising:
(a) electrodes configured for effecting droplet operations transporting droplets on a surface;
(b) a sensor arranged in proximity to one or more of the electrodes establishing a detection window on the surface for detection of one or more properties of one or more droplets on the surface;
wherein the electrodes establish at least two pathways for transport of droplets into the detection window.

2. The droplet actuator of claim 1 comprising a droplet on the one or more paths of electrodes.

3. The droplet actuator of claim 1, comprising a droplet on the one or more paths of electrodes in the detection window.

4. The droplet actuator of claim 1, wherein the droplet is partially or completely surrounded by a filler fluid.

5. The droplet actuator of claim 4 wherein the filler fluid comprises an oil.

6. The droplet actuator of claim 5 wherein the oil comprises a silicone oil.

7. The droplet actuator of claim 1, wherein the detection spot is aligned with a hydrophilic patch on the surface.

8. The droplet actuator of claim 1, comprising a substrate and a perimeter enclosing the surface and configured to provide a gap in which the droplet operations may be conducted.

9. The droplet actuator of claim 2, wherein the droplet is disposed between the surface and a separate substrate.

10. The droplet actuator of claim 3 wherein the droplet comprises beads.

11. The droplet actuator of claim 3 wherein the droplet comprises biological cells.

12. The droplet actuator of claim 1, wherein the electrode paths are arranged generally radially with respect to a point located in the detection window.

13. The droplet actuator of claim 1, wherein the electrode paths are arranged generally radially with respect to a center of the detection window.

14. The droplet actuator of claim 1, wherein the electrode paths are arranged generally radially relative to a central electrode positioned in the detection window.

15. The droplet actuator of claim 1, wherein the electrode paths are arranged generally radially relative to an electrode loop positioned at least partially within the detection window.

16. The droplet actuator of claim 1, wherein the electrode paths are arranged generally radially relative to a central electrode loop positioned generally concentrically within the detection window.

17. The droplet actuator of claim 1, wherein the electrode paths are:
(a) arranged generally radially relative to a center of the detection window; and
(b) connected to each other by one or more additional electrode paths.

18. The droplet actuator of claim 17 wherein the one or more additional electrode paths comprise a loop positioned generally concentrically outside the detection window.

19. The droplet actuator of claim 2, wherein the droplet operations comprise electrode-mediated droplet operations.

20. The droplet actuator of claim 2, wherein the droplet operations comprise electrowetting-mediated droplet operations.

21. The droplet actuator of claim 2, wherein the droplet operations comprise dielectrophoresis-mediated droplet operations.

22. The droplet actuator of claim 1, wherein the electrode paths establish a single path to each detection spot in each detection window.

23. The droplet actuator of claim 1, wherein the electrode paths establish two or more paths to a single detection spot in a detection window.

24. The droplet actuator of claim 1, wherein the electrode paths establish at least three pathways for transport of droplets into the detection window.

25. The droplet actuator of claim 1, wherein the electrode paths establish at least six pathways for transport of droplets into the detection window.

26. The droplet actuator of claim 1, wherein the electrodes are established in a polygonal pattern comprising polygonal electrodes, wherein each electrode has five or more sides.

27. The droplet actuator of claim 1, wherein the electrodes comprise:
(a) electrodes established in a regular rectagonal array; and
(b) electrodes converging from the rectagonal array into a detection window.

28. The droplet actuator of claim 29 wherein the unit cells comprise at least one nucleic acid amplification unit cell.

29. The droplet actuator of claim 1, wherein the electrode paths join the detection window with two or more droplet actuator unit cells.

30. The droplet actuator of claim 29 wherein the unit cells comprise at least one affinity assay unit cell.

31-86. (canceled)
